(19) United States
(12) Patent Application Publication
(10) Pub. No.: US 2010/0332010 A1
(43) Pub. Date: Dec. 30, 2010

(54) SEASONING PLASMA PROCESSING SYSTEMS

(76) Inventors: Brian Choi, Fremont, CA (US); Vijayakumar C. Venugopal, Berkeley, CA (US)

Correspondence Address: IPSG, P.C., P.O. BOX 700640, SAN JOSE, CA, 95170, US

(21) Appl. No.: 12/499,657

(22) Filed: Jul. 8, 2009

Related U.S. Application Data
(60) Provisional application No. 61/222,021, filed on Jun. 30, 2009.

(51) Int. Cl. G06F 17/00; G06F 15/00

(52) U.S. Cl. 700/108; 702/182; 700/121

(57) ABSTRACT

A system for facilitating seasoning a plasma processing chamber. The system includes a computer-readable medium storing a chamber seasoning program (or CS program). The CS program includes code for receiving a first plurality of values and a second plurality of values of a set of parameters related to operation of the plasma processing chamber. The CS program includes code for ascertaining, using the first plurality of values and the second plurality of values, whether current values of the parameters have stabilized. The CS program also includes code for determining, using the second plurality of values but not the first plurality of values, whether the current values of parameters have stabilized within a predetermined range. The system may also include circuit hardware for performing one or more tasks associated with the CS program.

### CROSS REFERENCE TO RELATED APPLICATION

The present invention claims priority under 35 U.S.C. 119(e) to a commonly owned provisionally filed patent application entitled “SEASONING PLASMA PROCESSING SYSTEMS,” U.S. Application No. 61/222,021, Attorney Docket No. P2007P/LMRX-P180P1, filed on Jun. 30, 2009, by inventors Brian Choi and Vijayakumar C Venugopal, all of which is incorporated herein by reference.

### BACKGROUND OF THE INVENTION

The present invention is related to plasma processing systems. In particular, the present invention is related to seasoning plasma processing chambers of plasma processing systems.

Plasma processing systems, such as capacitively coupled plasma (CCP) systems, inductively coupled plasma (ICP) systems, and transformer coupled plasma (TCP) systems, are employed in various industries for fabricating devices on wafers. For example, the industries may include semiconductor, magnetic read/write and storage, optical system, and micro-electromechanical system (MEMS) industries. A plasma processing system may generate and sustain plasma in a plasma processing chamber to perform etching and/or deposition on a wafer such that device features may be formed on the wafer.

From time to time, a plasma processing chamber may need to be returned to a stable, optimal operating state with respect to critical parameters after the plasma processing chamber has stopped operation for a period of time because of, for example, one or more process faults, idleness, or preventive maintenance of parts of the plasma processing system. The process of returning the plasma processing chamber to the stable, optimal operating state is generally referred to as chamber seasoning, or CS. The plasma processing chamber typically needs to be seasoned to ensure desirable performance in processing wafers.

The CS process may typically involve processing a number of seasoning wafers (i.e., generic silicon wafers) and employing sensors to collect critical processing parameter values for determining the state of the chamber. A conventional plasma processing system typically includes only an insufficient number of sensors. As a result, data for some critical parameters pertaining to a CS process may be unavailable, and the state of the plasma processing chamber may not be correctly determined.

In addition, a conventional CS process may substantially rely on empirical experiments and expert experience. After some experiments, the experienced expert may determine and recommend the number of seasoning wafers needed to be processed in the chamber to bring the chamber to the stable, optimal operating state, or the seasoned state.

Relying on the experience of the expert, the conventional CS process may not be performed in a systematical manner. The number of seasoning wafers recommended by the expert may be inaccurate or suboptimal. If too many seasoning wafers are processed in the CS process—an event referred to as over-seasoning, much time (especially the time required for performing metrology) may be wasted, and accordingly much production capacity may be wasted. If too few seasoning wafers are processed in the CS process—an event referred to as under-seasoning, the under-seasoned or unseasoned plasma processing chamber with suboptimal values of critical processing parameters may be employed in processing production wafers, wherein the production wafers are relatively high cost filmed wafers. As a result, parts of the plasma processing chamber may be damaged, a substantial number of the production wafers may need to be scrapped and wasted, production time and other resources may be wasted, and/or the manufacturing yield may be undesirable.

### SUMMARY OF INVENTION

An embodiment of the invention is related to a system for facilitating seasoning a plasma processing chamber. The system includes a computer-readable medium storing at least a chamber seasoning program (or CS program). The CS program may include code for receiving at least a first plurality of parameter values and a second plurality of parameter values. The first plurality of parameter values and the second plurality of parameter values may be associated with a plurality of parameters related to operation of the plasma processing chamber. The first plurality of parameter values and the second plurality of parameter values may be derived from signals sensed by a plurality of sensors. The plurality of sensors may be configured for sensing the plurality of parameters. The CS program may also include code for ascertaining, using the first plurality of parameter values and the second plurality of parameter values, whether current values of the plurality of parameters have stabilized in view of a first set of criteria (which is a set of error tolerance criteria). The CS program may also include code for determining, using the second plurality of parameter values but not the first plurality of parameter values, whether the current values of the plurality of parameters have stabilized within a predetermined range according to a second set of criteria. The determining may be performed after the current values of the plurality of parameters have been ascertained to have stabilized according to the first set of criteria. The system may also include a set of circuit hardware for performing one or more tasks associated with the CS program.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a schematic block diagram illustrating a plasma processing system including a chamber seasoning system (or CS system) in accordance with one or more embodiments of the present invention.

FIG. 2 shows a schematic flowchart illustrating tasks/steps pertaining to the CS system for facilitating seasoning a plasma processing chamber in accordance with one or more embodiments of the present invention.

FIG. 3A shows a schematic flowchart illustrating tasks/steps for determining baseline information (including control limits) for facilitating seasoning a plasma processing chamber in accordance with one or more embodiments of the present invention.

FIG. 3B shows a schematic flowchart illustrating tasks/steps for computing parameter values and relevant statistical results in determining control limits for facilitating seasoning a plasma processing chamber in accordance with one or more embodiments of the present invention.

FIG. 3C shows a schematic flowchart illustrating tasks/steps for constructing chamber seasoning vectors in determining control limits for facilitating seasoning a plasma processing chamber in accordance with one or more embodiments of the present invention.

FIG. 3D shows a schematic flowchart illustrating tasks/steps for computing control limits for facilitating seasoning a plasma processing chamber in accordance with one or more embodiments of the present invention.

FIG. 3E shows a schematic flowchart illustrating tasks/steps for constructing chamber seasoning vectors in determining control limits for facilitating seasoning a plasma processing chamber in accordance with one or more embodiments of the present invention.

FIG. 3F shows a schematic flowchart illustrating tasks/steps for constructing a relative metric control limit and an absolute metric control limit for facilitating seasoning a plasma processing chamber in accordance with one or more embodiments of the present invention.

FIG. 4 shows a schematic flowchart illustrating tasks/steps for computing a relative metric and an absolute metric for facilitating seasoning a plasma processing chamber in accordance with one or more embodiments of the present invention.

FIG. 5 shows a schematic flowchart illustrating tasks/steps for determining whether a plasma processing chamber has stabilized in accordance with one or more embodiments of the present invention.

FIG. 6 shows a schematic flowchart illustrating tasks/steps for determining whether a plasma processing chamber has desirably stabilized in accordance with one or more embodiments of the present invention.

FIG. 7 shows a schematic flowchart illustrating tasks/steps pertaining to the CS system for facilitating seasoning a plasma processing chamber in accordance with one or more embodiments of the present invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer-readable medium on which computer-readable instructions for carrying out embodiments of the inventive technique are stored. The computer-readable medium may include, for example, semiconductor, magnetic, opto-magnetic, optical, or other forms of computer-readable medium for storing computer-readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

One or more embodiments of the invention are related to a chamber seasoning system (or CS system) for facilitating seasoning at least a plasma processing chamber. The CS system may include a computer-readable medium storing at least a chamber seasoning program (or CS program). The CS system may also include a set of circuit hardware for performing one or more tasks associated with the CS program.

The CS program may include code for receiving at least a first plurality of parameter values and a second plurality of parameter values. The first plurality of parameter values and the second plurality of parameter values may be associated with a plurality of parameters related to operation of the plasma processing chamber. The first plurality of parameter values and the second plurality of parameter values may be derived from signals sensed by a plurality of sensors. The sensors are configured to sense the plurality of parameters. Embodiments of the present invention may employ a sufficient amount of sensors (e.g., at least 3 sensors) properly configured to collect sufficient pertinent parameter data for monitoring the chamber seasoning. Advantageously, the state of the plasma processing chamber may be sufficiently accurately determined.

The CS program may also include code for ascertaining whether current values of the plurality of parameters have stabilized according to a first set of criteria (or first set of control limits). The tasks of the ascertaining may include using both the first plurality of parameter values and the second plurality of parameter values to compute a relative metric. The relative metric may be related to differences between the first plurality of parameter values and the second plurality of parameter values.

The CS program may also include code for determining whether the above-mentioned current values of the plurality of parameters have stabilized within a predetermined range according to a second set of criteria (or second set of control limits). The tasks of the determining may be performed after the current values of the plurality of parameters have been ascertained to have stabilized according to the first set of criteria. The tasks of the determining may include using the second plurality of parameter values but not the first plurality of parameter values to compute an absolute metric.

The CS system may automate the chamber seasoning process with minimum reliance on empirical experiments and expert experience. As a result, over-seasoning and under-seasoning may be substantially prevented. Advantageously, production resources may be conserved, production costs may be minimized, and the production yield may be maximized.

One or more embodiments of the invention are related to a plasma processing system that includes the abovementioned CS system.

One or more embodiments of the invention are related to a method pertaining to the above-mentioned CS system.

The features and advantages of the present invention may be better understood with reference to the figures and discussions that follow.

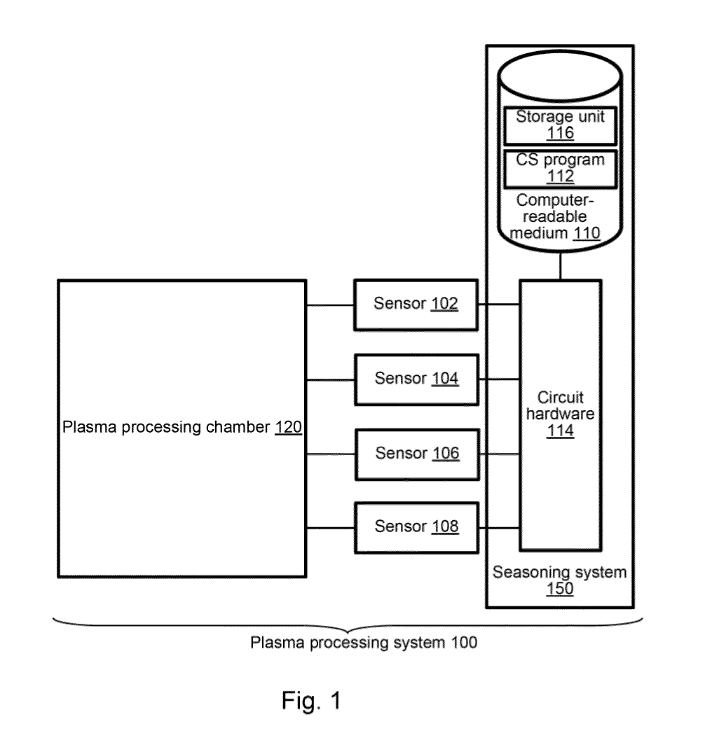

FIG. 1 shows a schematic block diagram illustrating a plasma processing system 100 in accordance with one or more embodiments of the present invention. Plasma processing system 100 may include a plasma processing chamber 120 for containing plasma for processing at least a wafer disposed inside plasma processing chamber 120.

Plasma processing system 100 may also include a plurality of sensors for sensing a plurality of parameters related to operation of plasma processing chamber 120. The sensors are illustrated by a sensor 102, a sensor 104, a sensor 106, and a sensor 108 in the example of FIG. 1. The sensors may include one or more of a voltage-current probe (or VI probe), an optical sensor, a temperature sensor, a pressure sensor, etc. The parameters may include electrical, mechanical, and/or chemical parameters related to one or more of the temperature, the outgassing issues, the surface conditions, etc. pertinent to the seasoning of plasma processing chamber 120. Including a sufficient amount of sensors deployed at suitable locations, embodiments of the invention may capture all critical data needed for the chamber seasoning process.

Plasma processing system 100 may also include a chamber seasoning system 150 (or CS system 150) coupled with the sensors for facilitating seasoning plasma processing chamber 120. CS system 150 may include a computer-readable medium 110 storing at least a chamber seasoning program 112 (or CS program 112). CS program 112 may include code for utilizing parameter values provided by the sensors to facilitate chamber seasoning. Computer-readable medium 110 may include one or more storage units (or “folders”) such as storage unit 1.16 (e.g., a folder) for storing baseline information utilized in the seasoning process. The baseline information may represent ranges of parameter values that define the steady state. The ranges of parameter values may be determined by target values of parameters pertinent to chamber seasoning and limits of acceptable noises and/or errors that cause deviation of parameter values from the target values.

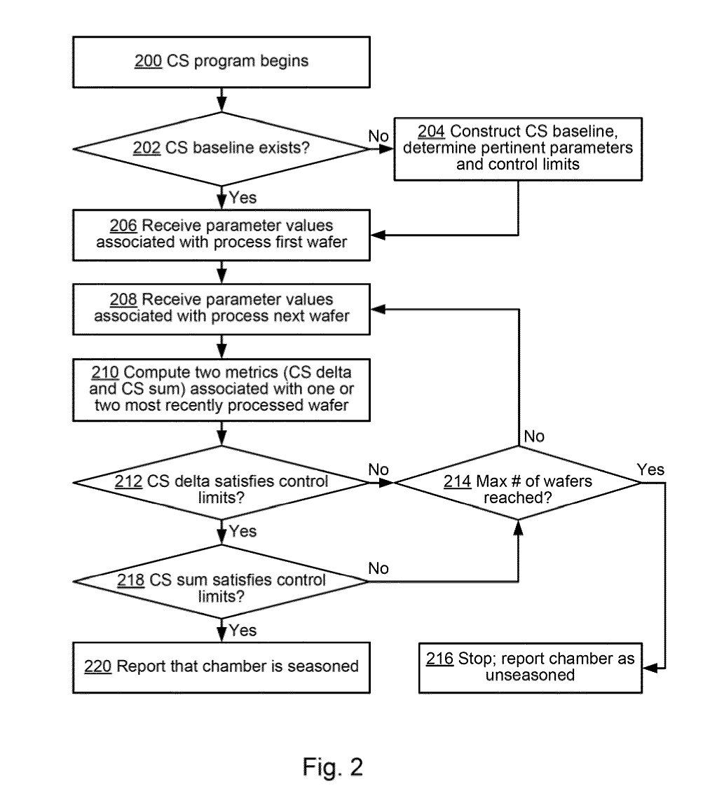

CS system 150 may also include a set of circuit hardware 114 for performing tasks associated with CS program 112 in facilitating seasoning plasma processing chamber 120. Examples of the tasks are discussed with references to FIGS. 2-6.

FIG. 2 shows a schematic flowchart illustrating tasks/steps pertaining to CS system 150 (illustrated in the example of FIG. 1) for facilitating seasoning a plasma processing chamber (e.g., plasma processing chamber 120 illustrated in the example of FIG. 1) in accordance with one or more embodiments of the present invention. In this application, the term “step” may represent a process step in facilitating chamber seasoning and/or a task related to CS system. 150. CS program 112 may include computer-readable code for performing the step and/or the task.

The tasks/steps may include step 200, in which CS system 150 may start CS program 112.

In step 202, CS system 150 may determine whether CS baseline information exists in a designated data storage unit, such as storage unit 116 illustrated in the example of FIG. 1. The baseline information may represent ranges of parameter values that define the steady state. The ranges of parameter values may be determined by target values of parameters pertinent to chamber seasoning (hereinafter referred to as “the pertinent parameters”) and limits of acceptable noises and/or errors that cause deviation of parameter values from the target values. If CS baseline information does not exist in the designated data storage unit, control is transferred to step 204; if CS baseline information exists in the designated data storage unit, control is transferred to step 206.

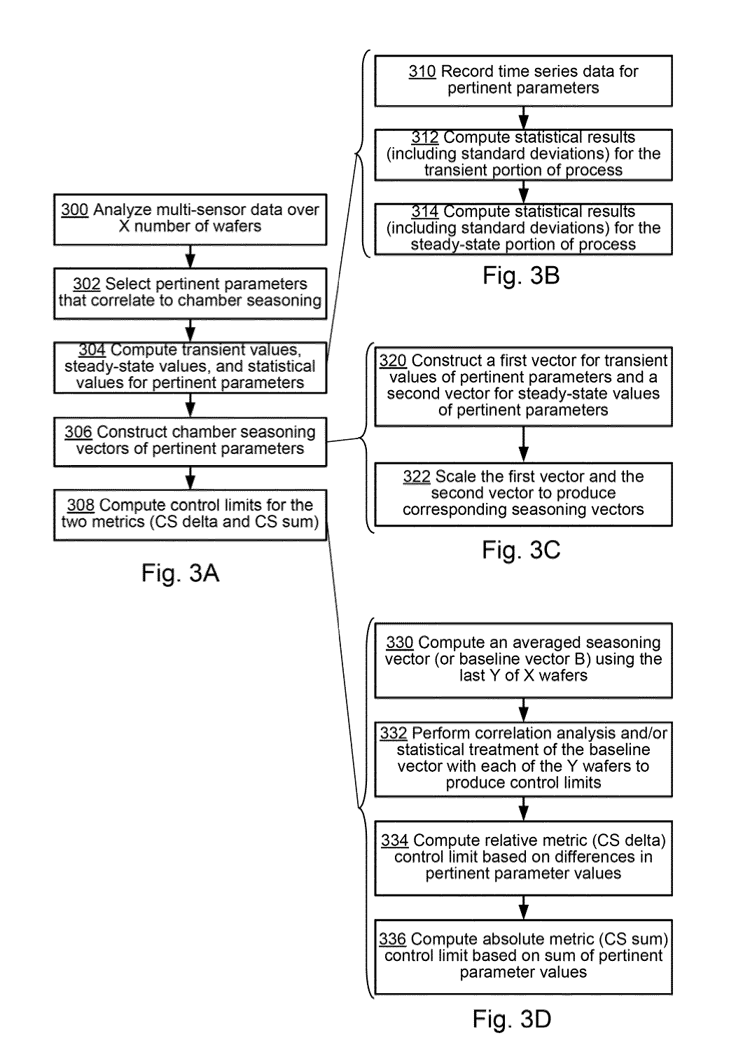

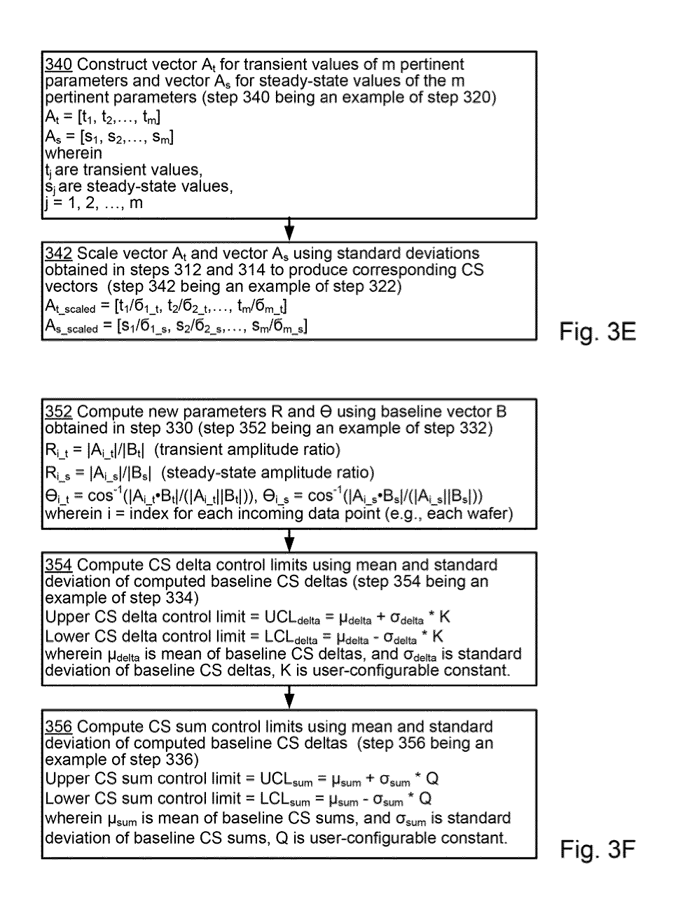

In step 204, CS system 150 may construct CS baseline information, including determining pertinent parameters and control limits. Example tasks/steps pertaining to constructing CS baseline information are discussed with references to the example of FIGS. 3A-3F.

In step 206, a first seasoning wafer may be processed in plasma processing chamber 120, and CS system 150 may receive a first plurality of parameter values associated with processing the first seasoning wafer. The first plurality of parameter values may be derived from signals received by the sensors, such as sensors 102, 104, 106, and 108, configured for sensing the parameters pertinent to seasoning plasma processing chamber 120.

In step 208, a next seasoning wafer may be processed in plasma processing chamber 120, and CS system 150 may receive a next plurality of parameter values associated with processing the currently processed seasoning wafer. The new parameter values also may be derived from signals received by the sensors sensing the parameters pertinent to seasoning plasma processing chamber 120.

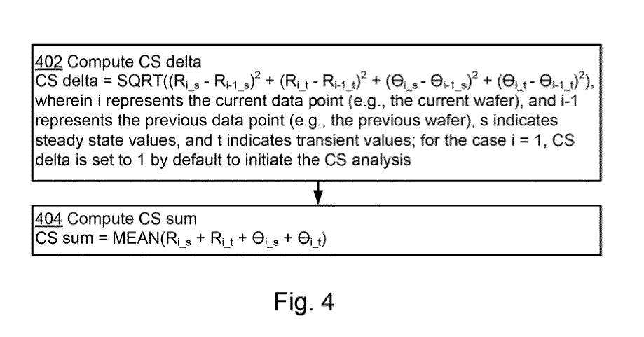

In step 210, CS system 150 may compute two metrics associated with the most recently processed seasoning wafer. CS system 150 may also compute the two metrics associated with the second (and even other) most recently processed seasoning wafer if the values have not been previously computed and retained. The two metrics may include a relative metric named CS delta and an absolute metric named CS sum. The relative metric represents the differences of pertinent parameter values associated with processing at least two consecutively processed seasoning wafers. The absolute metric represents the pertinent parameter values associated with processing the most recently processed seasoning wafer. Examples of CS delta and CS sum are discussed with reference to the example of FIG. 4.

In step 212, CS system 150 may use the relative metric (i.e., CS delta) and relevant control limits for the relative metric (e.g., obtained in step 202 and/or 204) to determine whether plasma processing chamber 120 has stabilized, i.e., whether the values of the pertinent parameters have converged within the control limits for the relative metric. Example tasks/steps related to step 212 are discussed with reference to the example of FIG. 4. If CS system 150 determines that plasma processing chamber 120 has not stabilized, control may be transferred to step 214; if CS system 150 determines that plasma processing chamber 120 has stabilized, control may be transferred to step 218.

In step 214, CS system 150 may determine whether a predetermined maximum number of seasoning wafers have been processed, i.e., whether a threshold quantity of processed seasoning wafers has been reached. Typically, plasma processing chamber 120 should have desirably stabilized, i.e., the pertinent parameters should have converged to a desirable range, before a known number of seasoning wafers have been processed, unless there is anomaly. The predetermined maximum number may be set to be equal to the known number or set to be greater than the known number. If the threshold quantity has been reached, control may be transferred to step 216; if the threshold quantity has not been reached, control may be transferred back to step 208, in which a next wafer may be processed and a next plurality of parameter values received by CS system 150.

In step 216, CS system 150 may stop seasoning-related tasks and may report that plasma processing chamber 120 is unseasoned. Using the parameter values that have been received by CS system 150 in the tasks/steps already performed, an engineer may be able to identify the cause of the anomaly and troubleshoot plasma processing system 100.

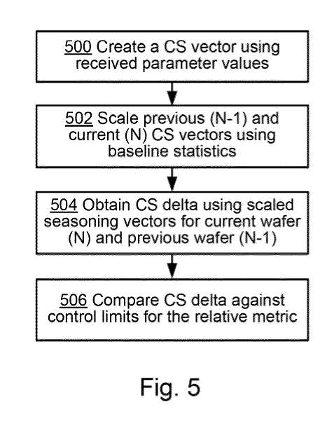

In step 218, CS system 150 may use the absolute metric (CS sum) and relevant control limits for the absolute metric (e.g., obtained in step 202 and/or 204) to determine whether plasma processing chamber 120 has desirably stabilized, i.e., whether the values of the pertinent parameters have converged within the desirable range. Example tasks/steps related to step 218 are discussed with reference to the example of FIG. 5. If CS system 150 determines that plasma processing chamber 120 has not desirably stabilized, control may be transferred to step 214, in which CS system 150 may determine whether the threshold quantity of processed seasoning wafers has been reached; if CS system 150 determines that plasma processing chamber 120 has desirably stabilized, control may be transferred to step 220.

In step 220, CS system 150 may report that chamber is seasoned, ready for processing production wafers.

As can be appreciated for the example of FIG. 2, CS system 150 may automate the chamber seasoning process with minimum reliance on empirical experiments and expert experience. Over-seasoning and under-seasoning may be substantially prevented. Advantageously, production resources may be conserved, production costs may be minimized, and the production yield may be maximized.

FIG. 3A shows a schematic flowchart illustrating tasks/steps for determining baseline information (including control limits) for facilitating seasoning a plasma processing chamber in accordance with one or more embodiments of the present invention. The tasks/steps illustrated in the example of FIG. 3A may represent example tasks/steps of step 204 (i.e., determining control limits) illustrated in the example of FIG. 2.

In step 300, CS system 150 may analyze pluralities of parameter values associated with processing a number of seasoning wafers, say X seasoning wafers. For instance, the number of seasoning wafers ran (X) for determining the pertinent parameters can be about 25 to 50% more than the number known, from empirical studies, to be required for the chamber to reach a seasoned state. The pluralities of parameter values may be derived from signals sensed by multiple sensors, for example, sensors 102, 104, 106, and 108 illustrated in the example of FIG. 1.

In step 302, CS system 150 may select, from the analyzed parameters, pertinent parameters that correlate to chamber seasoning. Parameters not pertinent to the chamber seasoning may be filtered out.

In step 304, CS system 150 may compute transient values and steady-state values for the pertinent parameters. A steady-state value is a parameter value that is within a range about a constant target value or at the boundary of the range; the steady-state value may also be considered a quasi-steady-state value given that the steady-state value may not be necessarily equal to the constant target value. A transient value is a parameter value that is outside the range. CS system 150 may also computer statistical values associated with the transient values and statistical values associated with the steady-state values.

In step 306, CS system 150 may construct chamber seasoning vectors using the pertinent parameters.

In step 308, CS system 150 may compute control limits for the relative metric (i.e., CS delta) and the absolute value (i.e., CS sum). Examples of CS delta and CS sum are discussed with reference to the example of FIGS. 3E and 3F.

Example tasks/steps related to step 304, step 306, and step 308 are discussed with reference to the examples of FIG. 3B, FIG. 3C, and FIG. 3D, respectively.

FIG. 3B shows a schematic flowchart illustrating tasks/steps for computing parameter values and relevant statistical results in determining control limits for facilitating seasoning a plasma processing chamber in accordance with one or more embodiments of the present invention. The tasks/steps illustrated in the example of FIG. 3B may represent example tasks/steps related to step 304 (computing transient values and steady-state values for the pertinent parameters) illustrated in the example of FIG. 3A.

In step 310, CS system 150 may record time series data for the pertinent parameters when processing the X number of seasoning wafers (illustrated in step 300 in the example of FIG. 3A). The time series data may include the transient values (outside the predetermined ranges) and the steady-state values (within the ranges or at the boundaries of the ranges) for the pertinent parameters.

In step 312, CS system 150 may compute statistical results for the transient portion of the CS process. The statistical results may include one or more of standard deviations, means, mediums, maximums, minimums, etc. of the transient values of the pertinent parameters.

In step 314, CS system 150 may compute statistical results for the steady-state portion of the CS process. The statistical results may include one or more of standard deviations, means, mediums, maximums, minimums, etc. of the steady-state values of the pertinent parameters.

FIG. 3C shows a schematic flowchart illustrating tasks/steps for constructing chamber seasoning vectors in determining control limits for facilitating seasoning a plasma processing chamber in accordance with one or more embodiments of the present invention. The tasks/steps illustrated in the example of FIG. 3C may represent example tasks/steps related to step 306 (constructing CS vectors of the permanent parameters) illustrated in the example of FIG. 3A.

In step 320, CS system 150 may construct a first vector for the transient values of pertinent parameters and a second vector for the steady-state values of the pertinent parameters.

In step 322, CS system 150 may scale the first vector and the second vector to produce corresponding CS vectors.

Example tasks/steps related to step 320 and step 322 are discussed with reference to the examples of FIG. 3E.

FIG. 3D shows a schematic flowchart illustrating tasks/steps for computing control limits for facilitating seasoning a plasma processing chamber in accordance with one or more embodiments of the present invention. The tasks/steps illustrated in the example of FIG. 3D may represent example tasks/steps related to step 308 (computing control limits for the two metrics) illustrated in the example of FIG. 3A.

In step 330, CS system 150 may compute an averaged seasoning vector, or baseline vector, denoted “B”, using the last Y of the X number of seasoning wafers. For instance, the last 10-20% of the X wafers (with a minimum of 5) can be used to compute the baseline vector “B.” Since the number of wafers run during baseline construction is usually grossly more than necessary for CS, the last 10-20% of wafers are “seasoned” and their corresponding sensor signals (i.e. seasoning vectors) will have stabilized.

In step 332, CS system 150 may perform correlation analysis and/or statistical treatment of the baseline vector with each of the Y wafers for producing control limits.

In step 334, CS system 150 may compute a relative metric control limit (i.e., CS delta control limit) based on differences in the values of the pertinent parameters.

In step. 336, CS system 150 may compute an absolute metric control limit (i.e., CS sum control limit) based on the sum of the values of the pertinent parameters.

Example tasks/steps related to step 332, step 334, and step 336 are discussed with reference to the examples of FIG. 3F.

FIG. 3E shows a schematic flowchart illustrating tasks/steps for constructing chamber seasoning vectors in determining control limits for facilitating seasoning a plasma processing chamber in accordance with one or more embodiments of the present invention. The tasks/steps illustrated in the example of FIG. 3E may represent example tasks/steps related to step 320 and step 322 illustrated in the example of FIG. 3C (constructing CS vectors).

Step 340 may represent an example of step 320 illustrated in the example of FIG. 3C. In step 340, assuming there are m pertinent parameters, CS system 150 may construct a vector A, for the transient values of the m pertinent parameters and a vector A, for the steady-state values of the m pertinent parameters. Aₜ and Aₛ may be mathematically represented as follows:

Aₜ=[t₁, t₂, . . . , tₘ]

Aₛ=[s₁, s₂, . . . , sₘ]

wherein

tⱼ are transient values,

sⱼ are steady-state values, and

j=1, 2, . . . , m.

Step 342 may represent an example of step 322 illustrated in the example of FIG. 3C. In step 342, CS system 150 may scale vector Aₜ and vector Aₛ using standard deviations obtained in steps 312 and 314 to produce corresponding CS vectors. The CS vectors may be mathematically represented as follows:

Aₜ_{_{—}}_{scaled}=[t₁/σ₁_{_{—}}ₜ, t₂/σ₂_{_{—}}ₜ, . . . , tₘ/σₘ_{_{—}}ₜ]

Aₛ_{_{—}}_{scaled}=[s₁/σ₁_{_{—}}ₛ, s₂/σ₂_{_{—}}ₛ, . . . , sₘ/σₘ_{_{—}}ₛ]

FIG. 3F shows a schematic flowchart illustrating tasks/steps for constructing a relative metric control limit and an absolute metric control limit for facilitating seasoning a plasma processing chamber in accordance with one or more embodiments of the present invention. The tasks/steps illustrated in the example of FIG. 3F may represent example tasks/steps related to step 332, step 334, and step 336 illustrated in the example of FIG. 3D (computing control limits).

Step 352 may represent an example of step 332 illustrated in the example of FIG. 3D. In step 352, CS system 150 may compute new parameters R and ⊖ using the baseline vector B obtained in step 330 illustrated in the example of FIG. 3D. R and ⊖ may be mathematically represented as follows:

Rᵢ_{_{—}}ₜ=|Aᵢ_{_{—}}ₜ/|Bₜ| (transient amplitude ratio)

Rᵢ_{_{—}}ₛ=|Aᵢ_{_{—}}ₛ/|Bₛ| (steady-state amplitude ratio)

⊖ᵢ_{_{—}}ₜ=cos⁻¹(|Aᵢ_{_{—}}ₜ•Bₜ|/(|Aᵢ_{_{—}}ₜ∥Bₜ|))

⊖ᵢ_{_{—}}ₛ=cos⁻¹(|Aᵢ_{_{—}}ₛ•Bₛ|/(|Aᵢ_{_{—}}ₛ∥Bₛ|))

wherein i=index for each incoming data point (e.g., each wafer), t indicates transient computations/values, and s indicates steady-state computations/values.

Step 354 may represent an example of step 334 illustrated in the example of FIG. 3D. In step 354, CS system 150 may compute CS delta control limits using the mean value and the standard deviation of the CS deltas from the baseline case. The CS deltas from the baseline case may be mathematically represented as follows:

The CS delta control limits may be mathematically represented as follows:

UCL_{delta}=μ_{delta}+σ_{delta}*K

LCL_{delta}=μ_{delta}−σ_{delta}*K

wherein UCL_{delta} is the upper control limit for CS delta values,

LCL_{delta} is the lower control limit for CS delta values,

μ_{delta} is the mean value of the baseline CS delta values,

σ_{delta} is the standard deviation of the baseline CS delta values, and

K is a user-configurable constant for configuring CS delta control limits.

Step 356 may represent an example of step 336 illustrated in the example of FIG. 3D. In step 356, CS system 150 may compute CS sum control limits using the mean value and the standard deviation of the CS sums from the baseline case. The CS sum for the baseline case may be mathematically represented as follows:

The CS sum control limits may be mathematically represented as follows:

UCLₛᵤₘ=μₛᵤₘ+σₛᵤₘ*Q

LCLₛᵤₘ=μₛᵤₘ−σₛᵤₘ*Q

wherein UCLₛᵤₘ is the upper control limit for CS sum values,

LCLₛᵤₘ is the lower control limit for CS sum values,

μₛᵤₘ is the mean value of the baseline CS sum values,

σₛᵤₘ is the standard deviation of the baseline CS sum values, and

Q is a user-configurable constant for configuring CS sum control limits, Q=K in one or more embodiments.

FIG. 4 shows a schematic flowchart illustrating tasks/steps for computing a relative metric and an absolute metric for facilitating seasoning a plasma processing chamber in accordance with one or more embodiments of the present invention. The tasks/steps illustrated in the example of FIG. 4 may represent example tasks/steps related to step 210 illustrated in the example of FIG. 2 (computing CS delta and CS sum).

In step 402, CS system 150 may compute the CS delta associated with the most recently processed seasoning wafer. The CS delta may be mathematically represented as follows:

CS delta=SQRT((Rᵢ_{_{—}}ₛ−Rᵢ₋₁_{_{—}}ₛ)²+(Rᵢ_{_{—}}ₜ−Rᵢ₋₁_{_{—}}ₜ)²+(⊖ᵢ_{_{—}}ₛ−⊖ᵢ₋₁_{_{—}}ₛ)²+(⊖ᵢ_{_{—}}ₜ−⊖ᵢ₋₁_{_{—}}ₜ)²)

wherein i represents the current data point (e.g., associated with the most recently processed seasoning wafer), i−1 represents the previous data point (e.g., associated with the second most recently processed seasoning wafer), and the subscripts s and t indicate steady-state and transient computations, respectively. For the case i=1, CS delta is set to 1 by default to initiate the CS analysis.

In step 404, CS system 150 may compute the CS sum associated with the most recently processed seasoning wafer. The CS sum may be mathematically represented as follows:

CS sum=MEAN(Rᵢ_{_{—}}ₛ+Rᵢ_{_{—}}ₜ+⊖ᵢ_{_{—}}ₛ+⊖ᵢ_{_{—}}ₜ)

FIG. 5 shows a schematic flowchart illustrating tasks/steps for determining whether a plasma processing chamber has stabilized in accordance with one or more embodiments of the present invention. The tasks/steps illustrated in the example of FIG. 5 may be related to step 212 (i.e., determining whether chamber has stabilized) illustrated in the example of FIG. 2.

In step 500, CS system 150 may create a CS vector using the received plurality of pertinent parameter values.

In step 502, CS system 150 may scale the CS vector associated with a previously processed seasoning wafer, or wafer (N-1), and the CS vector associated with the currently processed seasoning wafer, or wafer (N), using baseline statistics, such as the standard deviation of the baseline values. As a result, scaled CS vectors may be generated. In one or more embodiments, the currently processed seasoning wafer may represent the most recently processed seasoning wafer, and the previously processed seasoning wafer may represent the second most recently processed seasoning wafer.

In step 504, CS system 150 may obtain the CS delta using the scaled CS vectors for the current wafer (N) and the previous wafer (N-1).

In step 506, CS system 150 may compare the CS delta against the control limits for the relative metric to determine whether the pertinent parameter values have converged, i.e., whether the plasma processing chamber has stabilized.

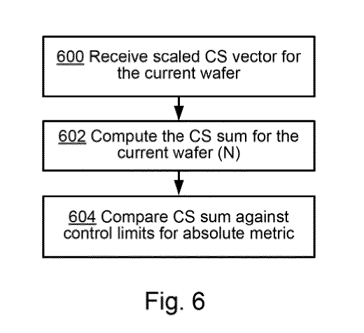

FIG. 6 shows a schematic flowchart illustrating tasks/steps for determining whether a plasma processing chamber has desirably stabilized in accordance with one or more embodiments of the present invention. The tasks/steps illustrated in the example of FIG. 6 may be related to step 218 (i.e., determining whether chamber has desirably stabilized) illustrated in the example of FIG. 2.

In step 600, CS system 150 may receive the scaled CS vector associated with the current wafer. The scaled CS vector may have been constructed in step 502.

In step 602, CS system 150 may compute the CS sum for the current wafer (N) using the scaled CS vector associated with the current wafer.

In step 604, CS system 150 may compare the CS sum against the control limits for the absolute metric to determine whether the pertinent parameter values have converged within a desirable range about the desirable target values, i.e., whether the plasma processing chamber has desirably stabilized.

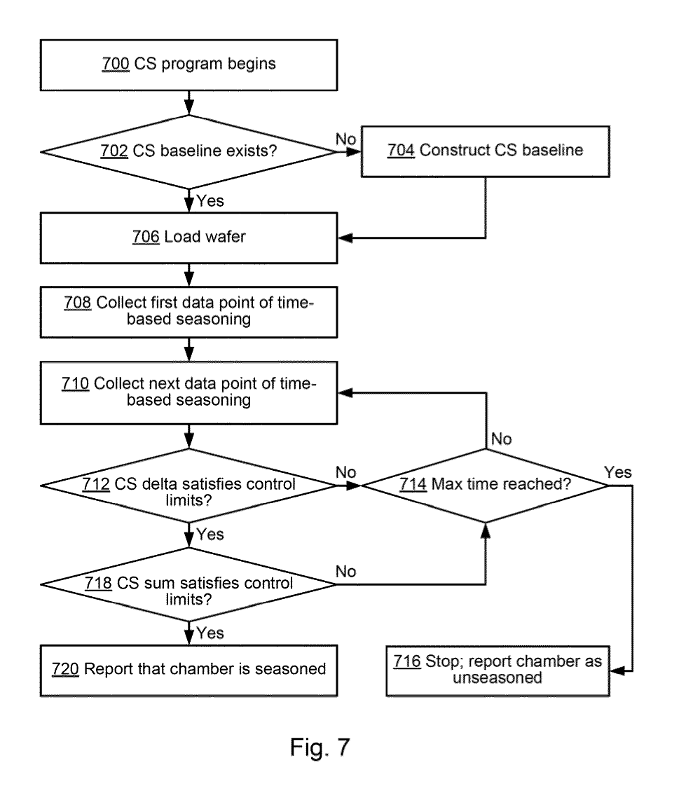

FIG. 7 shows a schematic flowchart illustrating tasks/steps pertaining to CS system 150 (illustrated in the example of FIG. 1) for facilitating seasoning a plasma processing chamber (e.g., plasma processing chamber 120 illustrated in the example of FIG. 1) in accordance with one or more embodiments of the present invention. Most of the tasks/steps illustrated in the example of FIG. 7 may be similar to most of the tasks/steps illustrated in the example of FIG. 2. However, the tasks/steps of the example of FIG. 2 provide a wafer quantity threshold in determining whether plasma processing chamber 120 has been seasoned; alternatively or additionally, the tasks/steps of the example of FIG. 7 provide a time threshold in determining whether plasma processing chamber 120 has been seasoned.

In step 700, CS system 150 may start CS program 112.

In step 702, CS system 150 may determine CS baseline information exists in a designated data storage unit, such as storage unit 116 illustrated in the example of FIG. 1. If CS baseline information does not exist in the designated data storage unit, control is transferred to step 704; if CS baseline information exists in the designated data storage unit, control is transferred to step 706.

In step 704, CS system 150 may construct the CS baseline information.

In step 706, at least one seasoning wafer may be loaded into plasma processing chamber 120, such that CS system 150 may receive parameter values derived from signals sensed by sensors 102-108.

In step 708, CS system 150 may collect a first data point of time-based seasoning. The first data point may represent a first plurality of parameter values derived from signals sensed by sensors 102-108 during an initial period of time when processing the seasoning wafer in plasma processing chamber 120.

In step 710, CS system 150 may collect a next data point of time-based seasoning. The new data point may represent a new plurality of parameter values derived from signals sensed by sensors 102-108 during a new period of time when processing the seasoning wafer or a different seasoning wafer in plasma processing chamber 120.

In step 712, CS system 150 may use the relative metric (i.e., CS delta) and relevant control limits for the relative metric (e.g., obtained in step 702 and/or 704) to determine whether plasma processing chamber 120 has stabilized, i.e., whether the values of the pertinent parameters have converged within the control limits for the relative metric.

In step 714, CS system 150 may determine whether a predetermined maximum time (or time threshold) has been reached. Typically, plasma processing chamber 120 should have desirably stabilized, i.e., the pertinent parameters should have converged to a desirable range, within a known length of time, unless there is anomaly. The predetermined time threshold may be set to be equal to the known length of time or set to be greater than the known length of time. If the threshold time has been reached, control may be transferred to step 716; if the threshold time has not been reached, control may be transferred back to step 710, in which a next plurality of parameter values may be received by CS system 150.

In step 716, CS system 150 may stop the seasoning-related tasks and may report that plasma processing chamber 120 is unseasoned. Subsequently, troubleshooting may be performed.

In step 718, CS system 150 may use the absolute metric (CS sum) and relevant control limits for the absolute metric (e.g., obtained in step 702 and/or 704) to determine whether plasma processing chamber 120 has desirably stabilized, i.e., whether the values of the pertinent parameters have converged within the desirable range. If CS system 150 determines that plasma processing chamber 120 has not desirably stabilized, control may be transferred to step 714, in which CS system 150 may determine whether the threshold time has been reached; if CS system 150 determines that plasma processing chamber 120 has desirably stabilized, control may be transferred to step 720.

In step 720, CS system 150 may report that chamber is seasoned, ready for processing production wafers.

The embodiments illustrated in the example of FIG. 7 may automate the chamber seasoning process with minimum reliance on empirical experiments and expert experience. Over-seasoning and under-seasoning may be substantially prevented. In addition, with time-based chamber seasoning, consumption of seasoning wafers may be minimized, and time consumed for loading and unloading seasoning wafers also may be minimized.

As can be appreciated from the foregoing, embodiments of the present invention may employ a sufficient amount of sensors properly configured to collect sufficient pertinent parameter data for performing chamber seasoning. Accordingly, the state of the plasma processing chamber may be sufficiently accurately determined. Embodiments of the invention may also automate the chamber seasoning process with minimum reliance on empirical experiments and expert experience. As a result, over-seasoning and under-seasoning may be substantially prevented. Advantageously, production resources may be conserved, production costs may be minimized, and the production yield may be maximized.

Embodiments of the invention may also minimize the consumption of seasoning wafers in chamber seasoning processes. Advantageously, costs associated with seasoning wafers may be minimized, and time consumed for loading and unloading seasoning wafers also may be minimized.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A system for facilitating seasoning a plasma processing chamber, the system comprising:
a computer-readable medium storing at least a chamber seasoning program, the chamber seasoning program including at least:
code for receiving at least a first plurality of parameter values and a second plurality of parameter values, the first plurality of parameter values and the second plurality of parameter values being associated with a plurality of parameters related to operation of the plasma processing chamber, the first plurality of parameter values and the second plurality of parameter values being derived from signals sensed by a plurality of sensors, the plurality of sensors being configured for sensing the plurality of parameters,
code for ascertaining, using the first plurality of parameter values and the second plurality of parameter values, whether current values of the plurality of parameters have stabilized in view of a first set of criteria, and code for determining, using the second plurality of parameter values but not the first plurality of parameter values, whether the current values of the plurality of parameters have stabilized within a predetermined range according to a second set of criteria, the determining being performed after the current values of the plurality of parameters have been ascertained to have stabilized according to the first set of criteria; and
a set of circuit hardware for performing one or more tasks associated with the chamber seasoning program.

2. The system of claim 1 wherein
the first plurality of parameter values is derived from first signals sensed during processing a first wafer,
the second plurality of parameter values is derived from second signals sensed during processing a second wafer, and
the second wafer is processed after the first wafer has been processed.

3. The system of claim 1 wherein the first plurality of parameter values and the second plurality of parameter values are derived from signals sensed during processing a same wafer.

4. The system of claim 1 further comprising code for computing a relative metric related to differences between the first plurality of parameter values and the second plurality of parameter values.

5. The system of claim 1 further comprising code for computing an absolute metric using the second plurality of parameter values but not the first plurality of parameter values.

6. The system of claim 1 further comprising:
code for constructing a first vector using the first plurality of parameter values;
code for constructing a second vector using the second plurality of parameter values;
code for scaling the first vector using a standard deviation value to produce a first scaled vector; and
code for scaling the second vector using the standard deviation value to produce a second scaled vector.

7. The system of claim 6 further comprising:
code for computing a relative metric using the first scaled vector and the second scaled vector, the relative metric being used for the ascertaining; and
code for computing an absolute metric using the second scaled vector but not the second scaled vector, the absolute metric being used for the determining.

8. A plasma processing system for generating plasma to process at least a wafer, the plasma processing system comprising:
a plasma processing chamber for containing the plasma;
a plurality of sensors for sensing a plurality of parameters related to operation of the plasma processing chamber;
a computer-readable medium storing at least a chamber seasoning program, the chamber seasoning program including at least:
code for receiving at least a first plurality of parameter values and a second plurality of parameter values, the first plurality of parameter values and the second plurality of parameter values being associated with the plurality of parameters, the first plurality of parameter values and the second plurality of parameter values being derived from signals sensed by the plurality of sensors,
code for ascertaining, using the first plurality of parameter values and the second plurality of parameter values, whether current values of the plurality of parameters have stabilized according to a first set of criteria, and
code for determining, using the second plurality of parameter values but not the first plurality of parameter values, whether the current values of the plurality of parameters have stabilized within a predetermined range according to a second set of criteria, the determining being performed after the current values of the plurality of parameters have been ascertained to have stabilized according to the first set of criteria; and
a set of circuit hardware for performing one or more tasks associated with the chamber seasoning program.

9. The plasma processing system of claim 8 wherein
the first plurality of parameter values is derived from first signals sensed during processing a first wafer,
the second plurality of parameter values is derived from second signals sensed during processing a second wafer, and
the second wafer is processed after the first wafer has been processed.

10. The plasma processing system of claim 8 wherein the first plurality of parameter values and the second plurality of parameter values are derived from signals sensed during processing a same wafer.

11. The plasma processing system of claim 8 further comprising code for computing a relative metric related to differences between the first plurality of parameter values and the second plurality of parameter values.

12. The plasma processing system of claim 8 further comprising code for computing an absolute metric using the second plurality of parameter values but not the first plurality of parameter values.

13. The plasma processing system of claim 8 further comprising:
code for constructing a first vector using the first plurality of parameter values;
code for constructing a second vector using the second plurality of parameter values;
code for scaling the first vector using a standard deviation value to produce a first scaled vector; and
code for scaling the second vector using the standard deviation value to produce a second scaled vector.

14. The plasma processing system of claim 13 further comprising:
code for computing a relative metric using the first scaled vector and the second scaled vector, the relative metric being used for the ascertaining; and
code for computing an absolute metric using the second scaled vector but not the second scaled vector, the absolute metric being used for the determining.

15. A method for facilitating seasoning a plasma processing chamber, the method comprising:
receiving a first plurality of parameter values and a second plurality of parameter values, each of the first plurality of parameter values and the second plurality of parameter values being associated with a plurality of parameters related to operation of the plasma processing chamber, the first plurality of parameter values and the second plurality of parameter values being derived from signals sensed by a plurality of sensors, the plurality of sensors being configured for sensing the plurality of parameters;
ascertaining, using the first plurality of parameter values and the second plurality of parameter values, whether current values of the plurality of parameters have stabilized according to a first set of criteria; and
determining, using the second plurality of parameter values but not the first plurality of parameter values, whether the current values of the plurality of parameters have stabilized within a predetermined range according to a second set of criteria, the determining being performed after the current values of the plurality of parameters have been ascertained to have stabilized according to the first set of criteria.

16. The method of claim 15 further comprising:
deriving the first plurality of parameter values from first signals sensed during processing a first wafer,
deriving the second plurality of parameter values from second signals sensed during processing a second wafer, and
processing the second wafer after the first wafer has been processed.

17. The method of claim 15 further comprising deriving the first plurality of parameter values and the second plurality of parameter values from signals sensed during processing a same wafer.

18. The method of claim 15 further comprising computing a relative metric related to differences between the first plurality of parameter values and the second plurality of parameter values.

19. The method of claim 15 further comprising computing an absolute metric using the second plurality of parameter values but not the first plurality of parameter values.

20. The method of claim 15 further comprising:
constructing a first vector using the first plurality of parameter values;
constructing a second vector using the second plurality of parameter values;
scaling the first vector using a standard deviation value to produce a first scaled vector; and
scaling the second vector using the standard deviation value to produce a second scaled vector;
computing a relative metric using the first scaled vector and the second scaled vector, the relative metric being used for the ascertaining; and
computing an absolute metric using the second scaled vector but not the second scaled vector, the absolute metric being used for the determining.
